(19) United States
(12) Patent Application Publication
(10) Pub. No.: US 2025/0034003 A1
(43) Pub. Date: Jan. 30, 2025

(54) COMPOSITIONS METHODS AND SYSTEMS FOR REDUCING THE CONCENTRATON OF CYA AND OTHER CONTAMINANTS IN WATER AND OTHER AQUEOUS SOLUTIONS

(71) Applicant: Surfatas Corporation, LLC, Huntersville, NC (US)

(72) Inventors: Glenn F. Cueman, Denver, NC (US); Arvind S. Patil, Davidson, NC (US); Selena Rhodes, Charlotte, NC (US)

(21) Appl. No.: 18/666,660

(22) Filed: May 16, 2024

Related U.S. Application Data
(60) Provisional application No. 63/516,335, filed on Jul. 28, 2023.

(51) Int. Cl. C02F 1/42; B01J 41/07; B01J 41/09; C02F 1/28; C02F 1/40; C02F 101/38; C02F 103/42

(52) U.S. Cl. CPC C02F 1/42; B01J 41/07; B01J 41/09; C02F 1/283; C02F 1/40; C02F 2001/422; C02F 2101/38; C02F 2103/42

(57) ABSTRACT

A composition for reducing the concentration of cyanuric acid and other contaminants in treated recreational water, including swimming pools and other recreational bathing structures, said composition comprising at least one ion exchange resin and at least one surface-modified activated carbon, a pouch comprising the composition, and a method reducing the concentration of cyanuric acid and other contaminants in treated recreational water, said method comprising adding the composition to or putting the composition in contact with treated recreational water.

### FIELD

The present invention relates generally to compositions, methods, and systems for reducing the concentration of cyanuric acid and other contaminants in water and aqueous solutions, including swimming pools and other recreational bathing structures.

### BACKGROUND

Recreational bathing structures, such as swimming pools, can contain anywhere from less than 5,000 gallons to over 100,000 gallons of water. Treating such a volume of water on a continuous basis requires a very large and complicated filtration system, as well as the addition of large quantities of chlorine on a regular basis, which is extremely costly, and requires continual monitoring and maintenance. Treated recreational water may also be found in hot tubs/spas and water playgrounds, e.g., splash pads, water parks, and water slides.

A skimmer is an important component of a pool filtration system. The skimmer keeps the water free of large objects, grit, dirt, leaves, and other debris. The physical action of the skimmer is to draw surface water, containing any such objects, dirt, grit, etc., and capture the same in a fine screen strainer (e.g., skimmer basket), thereby returning filtered water to the pool. Skimmers usually work continuously, 24 hours a day, whether the pool is being used or not. The fine screen strainer basket contained in the skimmer needs to be regularly removed and cleaned, in order to remove captured debris therefrom.

Chlorine is the best decontaminator currently available for the disinfection of swimming pools and other recreational bathing structures. When chlorine is added to water in a swimming pool or similar structure, it forms a weak acid which kills bacteria and germs.

Chlorine is often introduced into the water in the form of hypochlorous acid (HCIO) or a salt thereof (NaClO). In an aqueous solution, hypochlorite ions (ClO⁻) exist in equilibrium with hypochlorous acid, chloride (Cl⁻), and molecular chlorine (Cl₂), depending on pH, temperature, and concentration conditions. However, when exposed to direct sunlight, the half-life of chlorine is drastically reduced. Specifically, when UV rays (i.e., sunlight) mix with the free chlorine in water from a pool or similar structure, the chlorine becomes oxidized. Such oxidation accelerates the breakdown of chlorine, causing a phenomenon known as “chlorine burn.” It is estimated that as much as 75-90% of chlorine is burned by sunlight in a period of time as short as two hours.

Cyanuric acid or CYA ((CNOH)₃) is used universally in recreational bathing structures to stabilize the concentration of chlorine that is added thereto for disinfection purposes. In order to prevent the rapid photodegradation of hypochlorite (ClO—), and to maintain an effective hypochlorite concentration, CYA is introduced into the system, thereby significantly slowing the chlorine/hypochlorite degradation process.

Cyanuric acid was first synthesized by Friedrich Wohler in 1829, by the thermal decomposition of urea and uric acid. Currently, CYA is industrially produced by thermal decomposition of urea with the release of ammonia:

3H₂N—CO—NH₂→[C(O)NH]₃+NH₃.

U.S. Pat. Nos. 4,360,671 and 3,415,822 describe methods for the preparation and production of cyanuric acid.

Cyanuric acid combines with chlorine to slow its oxidation, thus slowing the chlorine's burn rate. Instead of adding hypochlorous acid in the form of HCIO, or in the form of a salt thereof (i.e., NaClO), both of which decompose rapidly in the presence of sunlight, a “stabilized” version of chloride can be continuously added to a swimming pool or similar recreational bathing facility for disinfection. Trichloroisocyanuric acid (C(O)NCl)₃ and dichloroisocyanuric acid (C(O)NCl)₂(C(O)NH) are typical chlorinated CYA stabilizers used to extend the duration of active chlorine disinfection in the industry.

Addition of CYA slows the hypochlorite degradation process, but active chlorine still degrades or is consumed over time, and must be replenished continuously throughout the operating period. Since the most common and convenient means of introducing and replenishing chlorine in the water is in the form of CYA, the levels of CYA rise with each additional cycle of chlorine replenishment. This eventually results in the overstabilization of chlorine, with concomitant loss of the disinfection properties in the water.

Too high a level of CYA in the water can render chlorine ineffective. This is often referred to as “chlorine lock.” In essence, the concentration of CYA starts to build up, which reduces the strength and killing speed of chlorine, leading to unsanitary conditions and/or conditions which bring about growth of algae, among other issues. Overstabilization of chlorine (i.e., “chlorine lock”) generally occurs when the concentration of CYA reaches over 100 ppm (0.77 mM), and its presence in this range signifies that the water may no longer have sufficient levels of free chlorine for effective disinfection.

Several methods currently exist for removal of excess CYA from aqueous solutions. For example, adding melamine results in precipitation of melamine cyanurate, which is then removed by filtration (Somesla, 2013). However, the current state of the art for reducing high concentrations of CYA (e.g., concentrations>50 ppm) is the partial or complete draining of the pool or recreational bathing structure, and subsequent replacement with fresh water. In other words, partial or complete replacement of the water is required in order to reduce the concentration of CYA, which is extremely costly and undesirable.

Catalytic activated carbons, as disclosed herein, were developed and used mainly to treat chloramine, hydrogen sulfides, and bromates. This is the first use of catalytic activated carbons to remove cyanuric acid from swimming pools and other recreational bathing facilities.

The US Centers for Disease Control and Prevention (CDC) recommend a concentration of CYA of 15 parts per million (15 mg/L) for commercial pools, in order to stabilize the chlorine and maintain the concentration of free available chlorine at 2 ppm (2 mg/L). Pool chemical manufacturers instead recommend a CYA concentration of between 30 and 50 mg/L (30-50 ppm). In either case, a very fine balance must be kept so as to achieve an optimum CYA concentration (e.g., about 15 ppm) while simultaneously maintaining a sufficient concentration of free available chlorine for disinfection (e.g., about 2 ppm). High concentrations of CYA result in the overstabilization of chlorine, which in turn results in very low levels of free available chlorine (e.g., less than 1 ppm) and unhygienic pool conditions. When the CYA concentration exceeds 70 ppm, hardly any available chlorine is present in the water, leading to growth of germs and algae.

The present invention solves the problems associated with prior water disinfection systems, compositions, and methods, and provides novel mechanisms for treating water and other aqueous solutions, including water in swimming pools and other recreational bathing structures of all sizes.

None of the prior art discloses a composition, method, and/or system as disclosed herein, which are effective at reducing CYA concentrations in water and aqueous solutions. Additionally, none of the prior art discloses compositions, methods, and/or systems for removing contaminants from swimming pools and other recreational bathing facilities as disclosed herein.

### SUMMARY

According to an embodiment of the present invention, a composition for reducing the concentration of cyanuric acid in treated (e.g., with chlorine and CYA) recreational water is described. The composition comprises, consists of, or consists essentially of at least one ion exchange resin and at least one surface-modified activated carbon.

The anion-exchange resin may be weakly basic anion exchange resin.

The anion-exchange resin may comprise cationic functional groups, including tertiary amine functional groups. The anion-exchange resin may be a styrene-divinylbenzene-type anion-exchange resin.

The surface-modified activated carbon may be a catalytic activated carbon. For example, the surface-modified activated carbon may be a catalytic activated carbon containing up to 8% nitrogen.

A ratio of anion-exchange resin to surface-modified activated carbon may be, in some embodiments, from 10:90 to 90:10.

According to some embodiments of the present invention, the composition is provided in a pouch made of a porous material. For example, the porous material may be a woven or non-woven material, e.g., a nonwoven felt.

According to other embodiments, a method for reducing the concentration of cyanuric acid in treated recreational water is described. The method comprise, consists of, or consists essentially of a step of putting the treated recreational water in contact with the composition for reducing the concentration of cyanuric acid in treated recreational water described herein. As a result, greater than 90%, greater than 95%, greater than 96%, or greater than 97% of cyanuric acid present in the treated recreational water may be removed.

In some embodiments, the treated recreational water has a chlorine concentration in a range from 2 ppm to 20 ppm, 2 ppm, to 6 ppm, or 2 ppm to 4 ppm.

The cyanuric acid concentration of the treated recreational water put into contact with the composition may be greater than 50 ppm or as high as 100 ppm or more, i.e., above the amounts recommended by the CDC or pool chemical manufacturers.

In some embodiments, the composition for reducing the concentration of cyanuric acid in treated recreational water may be contained in a pouch made of a porous material. For example, the porous material may be a woven or non-woven material, e.g., a nonwoven felt.

In some embodiments, the pouch containing the composition is contained in a skimmer basket.

### DESCRIPTION OF THE DRAWINGS

FIG. 1 is a schematic drawing of a pouch containing a composition according to some embodiments described herein.

FIG. 2 is a schematic drawing of a pouch containing a composition according to some embodiments described herein, and a skimmer basket for holding the pouch.

### DETAILED DESCRIPTION

The present invention may be understood more readily by reference to the following detailed description of the invention, taken in connection with the accompanying drawing figures, all of which form a part of this disclosure. It is to be understood that this invention is not limited to the specific compositions, devices, methods, conditions or parameters described and/or shown herein, and that the terminology used herein is for the purpose of describing particular embodiments by way of example only, and is not intended to be limiting of the claimed invention. Any and all patents and other publications identified in this specification are incorporated by reference as though fully set forth herein.

Also, as used in the specification, including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

The ranges set forth herein include both the numbers at the end of each range and any and all conceivable numbers therebetween, as that is the very definition of a range. It is therefore to be understood that the ranges and limits mentioned herein include all ranges located within the prescribed limits (i.e., subranges). For example, a range of from “about 100 to about 200” is meant to also include ranges from 110 to 150, 170 to 190, 153 to 162, and 145.3 to 149.6, inter alia. Further, as another example, a limit of “up to about 7” also includes a limit of up to about 5, up to 3, and up to about 4.5, inter alia, as well as any and all ranges within the limit, such as from about 1 to about 5, and from about 3.2 to about 6.5, inter alia, as examples.

Unless otherwise indicated, all numbers expressing quantities of ingredients, properties, such as molecular weight, pH, reaction conditions, and so forth used in the specification and claims are to be understood as being modified in all instances by the term “about.” Accordingly, unless indicated to the contrary, the numerical parameters set forth in the specification and claims are approximations that may vary depending upon the desired properties sought to be obtained by the present invention.

As used herein, the terms “comprise”, “comprises”, “containing”; “has”, “have”, “having”; and “includes”, “include” and “including”; are open-ended transition terms used to transition from a subject recited before the term to one or more elements recited after the term, where the element or elements listed after the transition term are not necessarily the only elements that make up the subject.

The term weight percent or wt. % means the weight of a given material relative to the weight of a resulting composition which includes the raw material. For example, a composition having 10 wt. % of a skin penetration agent means that the composition includes 10 parts by weight of the penetrating agent relative to 100 parts of the total weight of the resulting composition.

The present invention is directed to compositions, methods, and systems for reducing the concentration of CYA and other contaminants in water and other aqueous solutions. The compositions, methods, and systems described herein are suitable for use in swimming pools or similar recreational bathing structures, and may also be suitable for use in other aquatic environments.

It has been discovered that the combination of at least two components described herein achieves synergistically superior results in terms of reducing the concentration of CYA in water and aqueous solutions. For example, a greater than 90%, a greater than 95%, or a greater than 977% reduction in CYA concentration may be observed. Furthermore, synergistic results are also achieved in terms of maintaining the CYA concentration in the most optimum range for purposes of stabilizing chlorine, while still maintaining the presence of an adequate concentration of free available chlorine for disinfection.

The novel composition described herein includes at least an ion exchange resin and at least a surface-modified activated carbon. In some embodiments, the composition comprises additional components in addition to the at least one ion exchange resin and the at least one surface-modified activated carbon, such as a Zeolitic adsorbent (for example CatioXorb 1000B, a synthetic Zeolitic adsorbent that removes heavy metals such as lead, cadmium and mercury (supplied by Surfatas)), arsenic absorbent (for example Arsenil (supplied by Surfatas) that removes Arsenic III and Arsenic V), phosphate remover (for example Arsenil (supplied by Surfatas) or AP2X (supplied by Aqueous Solutions Global)), and/or a Volatile Organic Compound (VOC) remover (for example coconut shell activated carbon MCMB (available from Filtrex, India)).

An ion-exchange resin is a resin or polymer that acts as a medium for ion exchange. Ion exchange resins remove harmful contaminants from liquids, replacing them with beneficial, desired ions.

In some embodiments, the ion exchange resin in the novel composition described herein is an anion exchange resin. The anion exchange resin may be, for example, a weakly basic anion exchange resin. As understood by those skilled in the art, resins using primary (amino), secondary, or tertiary amine groups as functional groups behave like weak bases, and are therefore called “weakly basic” anion exchange resins. In some embodiments, the weakly basic anion exchange resin may be a cross-linked polystyrene divinylbenzene. In some embodiments, the weakly basic anion exchange resin may be Resinex™ TPX-4503 supplied by Jacobi Corporation, which is a high purity, premium grade, weakly basic macroporous exchange resin. Alternatively, HWR™-406, supplied by Headwater Technologies, or combinations of HWR™-406 and Resinex™ TPX-4503 may be used. HWR™-406 and Resinex™TPX-4503 have identical compositions, but are provided by different sources. HWR™-406 is also a cross-linked polystyrene divinylbenzene resin with one or more tertiary amine functional groups.

The synergistic composition described herein also includes at least one surface-modified activated carbon. Activated carbon is a form of carbon which is processed or “activated” to have small, low-volume pores. The small pores increase the surface area available for adsorption and/or chemical reactions. Surface chemistry of activated carbon is the principal factor impacting or affecting adsorption. Surface modification can improve the activated carbon capacity to adsorb specific substances.

In the composition described herein, the at least one surface-modified activated carbon is not so limited, but may be a catalytic activated carbon. Catalytic Activated carbons may be produced from bituminous material, wood-coal, and coconut shell carbons. They are produced by exposing these materials to nitrogen containing compounds such as gaseous nitrogen, gaseous ammonia, nitriles, nitrosamines, cyanates, isocyanates, urea, and oximes. The objective of this treatment is to replace oxygens in the graphene structure of carbons with nitrogen. In order to do that the graphene platelets have to be separated and various sites have to made accessible by heating them to temperatures between 700° C. to 1200° C. The total amount of nitrogen-containing compounds added to the carbon is up to 8%. For example, the resulting catalytic activated carbon may comprise from 1% to 8% nitrogen, from 1% to 7% nitrogen, from 1% to 6% nitrogen, from 1% to 5% nitrogen, from 2% to 5% nitrogen, from 2% to 4% nitrogen, or from 2% to 3% nitrogen. In some embodiments, the catalytic activated carbon is a surface-modified activated carbon called “CPM-CYA,” distributed by Surfatas Corporation. Normal activated carbons are deficient in surface basic groups. As such, in order to induce affinity for nitrogenous CYA, CPM-CYA is exposed to nitrogen-containing compounds, such as ammonia and urea, at high temperatures (between 700 to 1200° C.) to dope the carbon with nitrogen, so as to create catalytic sites to react with CYA.

The ingredients of the composition described herein are present in an effective amount, that is, in sufficient quantities and combinations so as to be effective without adverse effects. In some embodiments, the proportion by weight of the at least one ion exchange resin to the at least one surface-modified activated carbon in the composition is from about 10:90 to about 90:10. In some embodiments, the proportion of the at least one ion exchange resin to the at least one surface-modified activated carbon is from about 20:80 to about 80:20. In some embodiments, the proportion of the at least one ion exchange resin to the at least one surface-modified activated carbon is from about 25:75 to about 75:25. In some embodiments, the proportion of the at least one ion exchange resin to the at least one surface-modified activated carbon is from about 30:70 to about 70:30. In some embodiments, the proportion of the at least one ion exchange resin to the at least one surface-modified activated carbon is 50:50 by weight.

In some embodiments, the novel composition described herein comprises Resinex™ TPX-4503 or HWR™-406 as the at least one ion exchange resin, and CPM-CYA as the at least one surface-modified activated carbon.

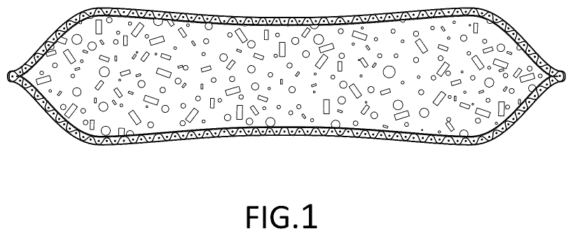

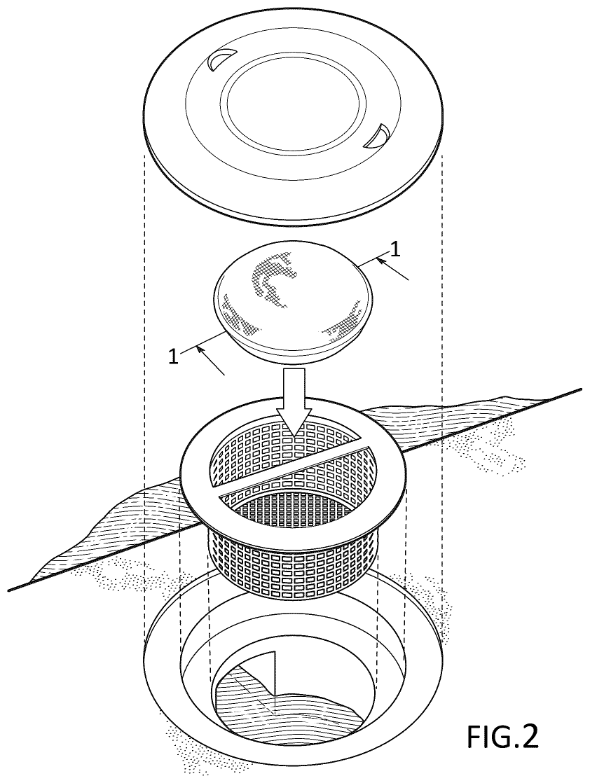

The at least one ion exchange resin and the at least one surface-modified activated carbon of the composition described herein may be added directly to water or an aqueous solution, or may be contained in one or more containers which are added thereto. FIG. 1 shows a cross-sectional view of an exemplary pouch that contains the composition described herein. In some embodiments, the pouch may be provided in a skimmer basket as depicted in FIG. 2. In FIG. 2, (1) indicates a cutline of the exemplary pouch, along which a cut may be made, resulting in the cross-sectional view of FIG. 1.

The system for reducing the concentration of CYA and other contaminants described herein includes one or more containers, said one or more containers containing the at least one ion exchange resin and the at least one surface-modified activated carbon described above.

In embodiments of the system described herein, the at least one ion exchange resin and the at least one surface-modified activated carbon are provided in separate containers. In other embodiments of the system, the at least one ion exchange resin and the at least one surface-modified activated carbon are provided in one and the same container. Additional materials may be present in the one or more containers.

Depending on the application thereof, many different types of containers, of many different shapes, may be suitable for the at least one ion exchange resin and the at least one surface-modified activated carbon. Some non-limiting examples thereof include porous containers, sacks, bags and pouches. The containers are porous containers with pores or openings with dimensions allowing for the retention of the ion exchange resin and surface-modified activated carbon within the container while also allowing the free flow of water, with its dissolved contaminants, to flow through the container and contact the ion exchange resin and surface-modified activated carbon. In one exemplary embodiment, the dimension of the pores is about 250 microns for retaining the ion exchange resin and surface-modified activated carbon with dimensions of about 300 to 800 microns or 20×50 US Mesh.

The containers may be made of various materials suitable for addition to or placement in swimming pools and other recreational bathing facilities. In some embodiments, the containers are made of permeable or semi-permeable materials suitable for placement in water or aqueous solutions. In some embodiments, the containers are made of non-woven fabric. In some embodiments, the containers are made of non-woven felt. In some embodiments, the containers are non-woven felt pouches.

The containers may have a variety of sizes, depending on the application thereof. For instance, for treatment of smaller structures and/or for smaller volumes of liquid (e.g., structures containing 10,000 gallons of water or less), containers containing up to approximately 1 lb. of material may be provided. For larger structures (e.g., pools containing more than 10,000 gallons of water), containers containing 1.5 lbs. or more of material may be used. For very large structures, containers containing 2 lbs. or more of material may be used.

In some embodiments, the system for reducing the concentration of CYA and other contaminants described herein includes at least one container containing Resinex™ TPX-4503 and/or HWR™-406 as the at least one ion exchange resin. In some embodiments, the system includes at least one container containing CPM-CYA as the at least one surface-modified activated carbon. In other embodiments of the system described herein, the Resinex™ TPX-4503 and/or HWR™-406, and the CPM-CYA may both be contained in one and the same container.

In the system described herein, the at least one ion exchange resin and the at least one surface-modified activated carbon are each contained in the one or more containers in an effective amount, that is, in sufficient quantities and combinations so as to be effective without adverse effects. In some embodiments, the proportion by weight of the at least one ion exchange resin to the at least one surface-modified activated carbon in the one or more containers is from about 10:90 to about 90:10. Other non-limiting examples of suitable proportions of the at least one ion exchange resin to the at least one surface-modified activated carbon in the system described herein are from about 20:80 to about 80:20, from about 25:75 to about 75:25, and 50:50 (all proportions by weight).

The at least one ion exchange resin and the at least one surface-modified activated carbon may be contained in the one or more containers of the system in various forms and states, including but not limited to, solid or granular form. The components may also be provided in other forms and/or states not listed herein, which are also encompassed within the scope of this application.

The novel water treatment method described herein includes treating water by adding thereto the at least one ion exchange resin and the at least one surface-modified activated carbon. The treatment method described herein controls and reduces the concentration of CYA in the water, and may also remove other contaminants therefrom.

In some embodiments of the method described herein, the at least one ion exchange resin and the at least one surface-modified activated carbon are added directly to the water or aqueous solution being treated. In other embodiments, one or more containers containing the at least one ion exchange resin and the at least one surface-modified activated carbon are placed in the water or aqueous solution to be treated.

In some embodiments of the method described herein, the water or aqueous solution to be treated is a swimming pool or recreational bathing structure. In some embodiments, the one or more containers containing the at least one ion exchange resin and the at least one surface-modified activated carbon are deposited or placed in the skimmer basket of the swimming pool or recreational bathing structure being treated.

The one or more containers added to the water or aqueous solution to be treated may also include components other than an ion exchange resin and a surface-modified activated carbon. By using appropriate media that reacts with and removes certain contaminants, the present method is able to not only control the concentration of CYA in a pool or bathing structure, but also to remove other contaminants, such as dissolved lead, mercury, cadmium, phosphates, nitrates, chloramines, chlorides, and volatile organic compounds, therefrom.

In some embodiments of the method described herein, the water or aqueous solution is treated by placing a predetermined amount of the composition described herein, comprising at least one ion exchange resin and at least one surface-modified activated carbon, in one or more containers, and subsequently placing the one or more containers in the water or aqueous solution being treated. Each component of the composition may be contained in a separate container, or all components may be contained in the same container. In some embodiments, the one or more containers may contain up to 2 lbs. of the composition described herein, with some embodiments containing 1-2 lbs. of the composition.

In some embodiments of the novel method described herein, water from a swimming pool or recreational bathing structure is treated by placing a predetermined amount of at least one ion exchange resin, and a predetermined amount of at least one surface-modified activated carbon, in the skimmer basket of said swimming pool or recreational bathing structure. In some embodiments, the method comprises adding up to 2 pounds of the at least one ion exchange resin and the at least one surface-modified activated carbon to the skimmer basket of the swimming pool or recreational bathing structure. In some embodiments, 1-2 pounds of the components described herein are added to the skimmer basket. The predetermined amount of at least one ion exchange resin and the predetermined amount of at least one surface-modified activated carbon are housed within a container, such as a pouch, as illustrated in FIGS. 1-3. The container is placed within the skimmer basket for treating the swimming pool or recreational bathing structure.

In embodiments of the method described herein, each of the at least one ion exchange resin and the at least one surface-modified activated carbon may be contained in a separate container. In other embodiments, all components may be contained in the same container. The one or more containers have the characteristics, features, and constitution as described above. In some embodiments, the one or more containers may be pouches. In certain embodiments, the pouches are made of nonwoven felt.

The at least one ion exchange resin and the at least one surface-modified activated carbon may be contained in the one or more containers in various forms and states, including but not limited to, solid or granular form. The components may also be provided in other forms and/or states not listed herein, which are also encompassed within the scope of this application.

Depending on the application thereof, the containers may have different shapes and sizes, as described above. The containers are porous containers with pores or openings with dimensions allowing for the retention of the ion exchange resin and surface-modified activated carbon within the container while also allowing the free flow of water, with its dissolved contaminants, to flow through the container and contact the ion exchange resin and surface-modified activated carbon. In one exemplary embodiment, the dimension of the pores is about 250 microns for retaining the ion exchange resin and surface-modified activated carbon with dimensions of about 300 to 800 microns or 20×50 US Mesh.

In embodiments of the novel method described herein, water is treated by placing predetermined amounts of Resinex™ TPX-4503 and/or HWR™-406 and CPM-CYA in the water to be treated. The TPX-4503 and/or HWR™-406 and the CPM-CYA may be contained in one or more containers, and the container(s) may be placed in the water being treated. The Resinex™ TPX-4503 and/or HWR™-406 and CPM-CYA may each be contained in a separate container, or both may be contained in the same container. In some embodiments, the Resinex™ TPX-4503 and/or HWR™-406 and CPM-CYA are each contained in a container, such as a nonwoven felt pouch. In some embodiments, the Resinex™ TPX-4503 and/or HWR™-406 and CPM-CYA are both contained in a single nonwoven felt pouch. In some embodiments, additional components besides Resinex™ TPX-4503 and/or HWR™-406 and CPM-CYA may be added to the water.

In embodiments of the method described herein, the at least one ion exchange resin and the at least one surface-modified activated carbon are each added to the water or aqueous solution being treated in an effective amount, that is, in sufficient quantities and combinations so as to be effective without adverse effects. In some embodiments, the proportion by weight of the at least one ion exchange resin to the at least one surface-modified activated carbon is from about 10:90 to about 90:10. Other non-limiting examples of suitable proportions of the at least one ion exchange resin to the at least one surface-modified activated carbon in accordance with the method described herein include: from about 20:80 to about 80:20, from about 25:75 to about 75:25, and 50:50 (all proportions are by weight).

### EXAMPLES

### Variation of Relative Ratios of Two Component Adsorbents on Removal of Cyanuric Acid

Various experiments were conducted to determine the reduction in CYA when the composition according to the present invention was placed in swimming pools. Table 1 shows the test data from various experiments wherein the proportion of the at least one ion exchange resin to the at least one surface-modified activated carbon is 50:50 by weight. The ion exchange resin utilized in these experiments is Resinex™ TPX-4503 and the surface-modified activated carbon is CPM-CYA and contained within a felt pouch as shown in FIGS. 1-3 and the felt pouch was placed in the skimmer basket. As shown in Table 1, the CYA within the water of the swimming pool was substantially reduced by the composition of the present invention.

### Experimental:

A solution of cyanuric acid was prepared by dissolving 0.1783 g of cyanuric acid in 500 ml distilled water and diluting it to 1000 ml to produce 180 ppm solution of cyanuric acid. A 1500 ml sample of this solution was sent to Pace Lab for confirmation by LC MS/MS instrument.

The following combinations of TPX-4503 and CPM-CYA were added to five 250 ml beakers as follows:
1.) 3 grams of TPX-4503—100% TPX-4503
2.) 2.7 grams of TPX-4503+0.3 grams of CPM-CYA—90:10 ratio
3.) 1.5 grams of TPX-4503+1.5 grams of CPM-CYA—50:50 ratio
4.) 0.3 grams of TPX-4503+2.7 grams of CPM-CYA—10:90 ratio
5. 3 grams of CPM-CYA—100% CPM-CYA

150 ml of above mentioned 180 ppm cyanuric acid solution was added to each of the five 250 ml beakers; they were each covered with plastic wrap and vortexed for 24 hours at 150 RPM, after which they were each sampled as follows:

Supernatant from each 250 ml beaker was drawn with a syringe fitted with a 1.2-micron filter at the end into amber glass sample bottle to be sent to Pace Labs for analysis of cyanuric acid by LC MS/MS.

### Results:

The results after analysis are reported in Table 1 below:

TABLE 1

| Ratio of TPX-4503 | | |
|---|---|---|
| to CPM-CYA | Mg/g Removed | % Removed |
| 100% TPX-4503 | 16.61 | 92.3 |
| 90:10 ratio | 17.172 | 95.4 |
| 50:50 ratio | 17.491 | 97.2 |
| 10:90 ratio | 17.404 | 96.7 |
| 100% CPM-CYA | 17.206 | 95.6 |

The highest synergistic removal of cyanuric acid appears to occur at a 50:50 or 1:1 ratio of TPX-4503 to CPM-CYA.

### Effect of Chlorine on Cyanuric Acid Removal by TPX-4503 and CPM-CYA

At CYA concentrations below approximately 15 ppm, chlorine is decomposed by sunlight, and the pool or recreational bathing structure becomes unhygienic. Conversely, at CYA concentrations higher than about 100 ppm to about 150 ppm, too much of chlorine is captured by the CYA, creating conditions which promote growth of algae, due to the absence of an adequate quantity of free available chlorine. The synergistic combination of the components described herein reduces the concentration of CYA in a swimming pool or similar recreational bathing structure and, furthermore, maintains the concentration of CYA in an optimal range of from about 15 ppm to about 50 ppm. This CYA concentration range allows a sufficient concentration of free available chlorine in the water, thereby maintaining the hygienic conditions thereof, while ensuring that there is still adequate chlorine in the stabilized state.

The objective of this experiment was to determine what effect the available chlorine (hypochlorite) has on the removal of cyanuric acid (CYA) by TPX-4503 and CPM-CYA. In the swimming pools there is a constant addition of CYA to stabilize the chlorine levels and of chlorine itself to replenish what is decomposed by sunlight and what is used up in pool disinfection. There exists a delicate balance in the concentration of CYA and Chlorine, that is optimal for the pools. It is recommended that for optimum operation of swimming pools, the concentration of CYA should be maintained between 15-50 ppm or 30-50 ppm and that of free available chlorine (hypochlorite) at around 2 ppm. However, in practice the concentration of CYA can sometimes approaches 100 ppm and higher and concentration of chlorine can exceed 4-6 ppm, when it starts irritating eyes of the swimmer. This experiment studies the performance of TPX-4503, which is a weak acid anion exchange resin made of styrene divinyl benzene polymer and which can be attacked and decomposed by high concentration of chlorine. CPM-CYA, which is the second component of the additive mixture is catalytic activated carbon that is capable of decomposing the chlorine to carbon dioxide and chloride because of its catalytic properties.

### Experimental:

The following experiment was performed to determine the resistance of TPX-4503 resin to freely available chlorine.

A 150 ppm cyanuric acid solution was produced by dissolving 0.5874 g of cyanuric acid in 500 mL of water, then diluting to one gallon (3.785 L). This solution was divided among four 1000 mL volumetric flasks labeled A, B, C, and D.

To achieve a free chlorine concentration of 2 ppm in Flask A, 0.02353 mL of 8.5% bleach solution was added to the flask.

To achieve a free chlorine concentration of 4 ppm in Flask B, 0.04706 mL of 8.5% bleach solution was added to the flask.

To achieve a free chlorine concentration of 6 ppm in Flask C, 0.07059 mL of 8.5% bleach solution was added to the flask.

To achieve a free chlorine concentration of 20 ppm in Flask D. 0.2353 mL of 8.5% bleach solution was added to the flask.

Eight beakers were prepared, four with one gram of TPX-4503 and four with a half gram of TPX-4503 and a half gram of CPM-CYA. TPX-4503 only beakers were labeled A B C and D, while TPX-4503/CPM-CYA beakers were labeled A4, B4, C4, and D4.

150 mL of solution A B C and D were added to each appropriately labeled beaker, after which the beakers were covered with plastic wrap and vortexed at 150 rpm for five days.

Supernatants from the Beakers were drawn with a syringe fitted with 1.2-micron filter into sample bottles and sent to Chembac Lab for Volatile analysis with GC-MS/GC-MS Head space for styrene monomer content.

Another set of samples were similarly drawn into amber glass bottles to be sent to Pace Labs for analysis of CYA by LC MS/MS.

Results of Styrene detected are shown in Table 2 below:

TABLE 2

| | Chlorine | Styrene |
|---|---|---|
| | Concentration | Concentration |
| Sample | (ppm) | (μg/g) |
| A - TPX-4503 only | 2.1 | <1 |
| A4- TPX-4503/ | 2.1 | <1 |
| CPM-CYA | | |
| B- TPX-4503 only | 4.2 | <1 |
| B4- TPX-4503/ | 4.1 | <1 |
| CPM-CYA | | |
| C- TPX-4503 only | 6 | <1 |
| C4- TPX-4503/ | 6.0 | <1 |
| CPM-CYA | | |
| D- TPX-4503 only | 20.4 | <1 |
| D4-TPX-4503/ | 20.3 | <1 |
| CPM-CYA | | |

Results of Cyanuric Acid Removal are shown in Table 3 below:

TABLE 3

| | Chlorine | CYA | |
|---|---|---|---|
| | Concentration | Concentration | CYA Removed- |
| Sample | (ppm) | (ppm) | mg/g |
| A- TPX-4503 only | 2.1 | 132 | 22 |
| A4-TPX-4503/ | 2.1 | 122 | 32 |
| CPM-CYA | | | |
| B- TPX-4503 only | 4.2 | 135 | 19 |
| B4-TPX-4503/ | 4.1 | 128 | 26 |
| CPM-CYA | | | |
| C- TPX-4503 only | 6 | 131 | 23 |
| C4- TPX-4503/ | 6.1 | 127 | 27 |
| CPM-CYA | | | |
| D- TPX-4503 only | 20.4 | 133 | 21 |
| D4- TPX-4503/ | 20.3 | 121 | 33 |
| CPM-CYA | | | |

### CONCLUSIONS

TPX-4503 is slightly affected by the presence of free chorine, but that effect is about the same in the presence of from 2 to 20 ppm chlorine.

CPM-CYA in each case is relatively unaffected by chlorine and appears to protect the TPX-4503. More CYA is removed when CPM-CYA is present than when TPX-4503 alone is used. For example, at ˜2 ppm chlorine, 45% more CYA is removed than with TPX-4503 alone. At ˜4 ppm chlorine, 37% more CYA is removed than with TPX-4503 alone. At ˜6 ppm chlorine, 17% more CYA is removed than with TPX-4503 alone. At ˜8 ppm chlorine, 57% more CYA is removed than with TPX-4503 alone.

Even at 20 ppm chlorine, there is no apparent degradation of the styrene divinyl benzene polymer, i.e., TPX-4503.

The above results are true even after five days of exposure. Both TPX-4503 and CPM-CYA continue to function well in removing CYA from water even in the presence of extremely high chlorine (hypochlorite) concentration.

Although the present invention has been illustrated and described herein with reference to preferred embodiments and specific examples thereof, it will be readily apparent to those of ordinary skill in the art that other embodiments and examples may perform similar functions and/or achieve like results. All such embodiments and examples are within the spirit and scope of the present invention and are intended to be covered by the following claims.

What is claimed is:

1. A composition for reducing the concentration of cyanuric acid in treated recreational water, the composition comprising:
an anion-exchange resin; and
a surface-modified activated carbon.

2. The composition of claim 1, wherein the anion-exchange resin is a weakly basic anion exchange resin.

3. The composition of claim 1, wherein the anion-exchange resin comprises tertiary amine functional groups.

4. The composition of claim 1, wherein the anion-exchange resin is a styrene-divinylbenzene-type anion-exchange resin.

5. The composition of claim 1, wherein the surface-modified activated carbon is a catalytic activated carbon having up to 8% nitrogen.

6. The composition of claim 1, further comprising one or more selected from the following: a zeolitic adsorbent, a synthetic zeolitic adsorbent that removes heavy metals such as lead, cadmium and mercury, an arsenic absorbent, a phosphate remover, and a VOC remover.

7. A pouch comprising the composition of claim 1, the pouch being made of a porous material.

8. The pouch of claim 7, wherein the porous material is a woven material or a non-woven material.

9. The pouch of claim 7, the pouch being a non-woven felt pouch.

10. A method for reducing the concentration of cyanuric acid in treated recreational water, comprising:
contacting the treated recreational water and the composition of claim 1.

11. The method of claim 10, wherein the treated recreational water is water from a pool, a hot tub/spa, or a water playground.

12. The method of claim 10, wherein the treated recreational water has a chlorine concentration in a range from 2 ppm to 20 ppm.

13. The method of claim 12, wherein the treated recreational water has a chlorine concentration in a range from 2 ppm and 6 ppm.

14. The method of claim 10, wherein the treated recreational water has a cyanuric acid concentration greater than 50 ppm.

15. The method of claim 10, wherein the composition of claim 1 is contained in a pouch made of a porous material.

16. The method of claim 15, wherein the porous material is a woven or non-woven material.

17. The method of claim 16, the pouch being a non-woven felt pouch.

18. The method of claim 15, wherein the pouch is contained in a skimmer basket.

19. The method of claim 10, wherein the anion-exchange resin is a weakly basic anion exchange resin.

20. The method of claim 10, wherein the surface-modified activated carbon is a catalytic activated carbon having up to 8% nitrogen.
